(19) United States
(12) Patent Application Publication
(10) Pub. No.: US 2009/0117935 A1
(43) Pub. Date: May 7, 2009

(54) PORTABLE ELECTRONIC DEVICE WITH OPERATIONAL INTERFACE CONTROLLED BY A PROXIMITY SENSOR

(75) Inventor: Olov Gredvall, Lund (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: SONY ERICSSON MOBILE COMMUNICATIONS AB, Lund (SE)

(21) Appl. No.: 11/915,177

(22) PCT Filed: Jun. 1, 2006
(86) PCT No.: PCT/EP2006/005222

§ 371 Date: May 14, 2008

Related U.S. Application Data
(60) Provisional application No. 60/689,275, filed on Jun. 10, 2005.

(30) Foreign Application Priority Data
Jun. 1, 2005 (EP) 05011775.3

(51) Int. Cl. H04M 1/00

(52) U.S. Cl. 455/550.1

(57) ABSTRACT

A portable electronic apparatus (1) and a method for controlling an operational interface of the portable electronic apparatus. The apparatus comprises a transmitter unit (10) including a transmitter (11); a receiver unit (20) including a receiver (21); and an operational interface. The transmitter and the receiver are arranged such that a signal transmitted by the transmitter (11) is received by the receiver (21) when at least the transmitter unit is facing towards and is positioned in proximity of an external surface (31, 44). The transmitter may be an LED, a cold cathode ray tube, or IR or UV transmitter. The receiver may be an optical sensor.

### TECHNICAL FIELD OF THE INVENTION

The present invention relates to a portable electronic apparatus comprising an operational interface and an activation unit for activating and deactivating at least one functionality of the operational interface. The invention also relates to a method for controlling the operational interface.

### DESCRIPTION OF RELATED ART

A portable electronic apparatus, such as a mobile terminal, may comprise a user interface including an input interface and/or an output interface. The input interface may be divided into an operational interface with devices required to control or adjust the apparatus and a functional interface with devices required for data communication. The operational interface may comprise various input devices, such as keypads, joysticks, and receivers. The functional interface may comprise microphones. The output interface may in the same way be divided into an operational interface and a functional interface. The operational interface may comprise various output devices, such as displays and/or LED:s (Light Emitting Diode). The functional interface may comprise loudspeakers. Each of the operational input interface and the operational output interface may include backlight illumination, e.g. for the keypad and/or the display.

The output interface and/or the backlight illumination may be activated from a passive mode to an active mode or switched on when an input device of the input interface is activated, e.g. by pressing a key, or when an application of the portable electronic apparatus is activated, such as in response to an incoming call or message. The backlight illumination and/or the output interface may be automatically switched off or inactivated, e.g. if the input interface has not been used for a predetermined period of time or when the application has been deactivated.

The portable electronic apparatus may have a design allowing it to be stored in a pocket or a bag when it is not used. This poses a risk that one of the input devices, which may be used to switch on an output device or the backlight, is unintentionally activated. Thus, the output device and/or the backlight illumination will be switched on even if the user did not intend to do so. Unintentional activation of the output device and/or the backlight illumination means that they will be unnecessarily switched on, resulting in waste of power, which is a valuable and scarce resource in a portable electronic apparatus.

### SUMMARY OF THE INVENTION

An object of the invention is to detect activation of at least one output device of a user interface of a portable electronic apparatus.

According to a first aspect, a portable electronic apparatus comprises a transmitter unit, a receiver unit, an operational interface, and an activation unit for controlling the operational interface. The transmitter unit and the receiver unit are arranged such that a signal transmitted by the transmitter unit is received by the receiver unit when the transmitter unit is facing towards and is positioned in proximity of an external surface. The receiver unit is arranged to issue a detection indication in response to receiving the signal. The activation unit is responsive to the detection indication.

The activation unit may be adapted to at least inactivate a portion of the operational interface in response to the detection indication.

The transmitter unit may comprise a signal generator arranged to generate a drive signal, such as a modulated drive signal, for generating the signal to be transmitted by the transmitter unit. The drive signal may have a predetermined duty cycle. The drive signal may, for example, be used for simultaneously and independently controlling the brightness of a light source and the frequency of an optical signal intended for the receiver unit. Furthermore, according to some embodiments, a voltage of the drive signal is arranged to oscillate during a first time period and the voltage of the drive signal is arranged to be zero during a second time period, wherein the combined first and second time periods have a repetition rate and the frequency of the drive signal during the first time period is higher than the repetition rate. In some embodiments, the brightness of the light source may be adjusted by controlling the relative length of the second time period in relation to the first time period.

A transmitter of the transmitter unit may be integrated with the operational interface. The transmitter may be an optical transmitter. The optical transmitter may be a backlight of the operational interface. Alternatively or additionally, the transmitter may be a LED positioned in proximity to a receiver of the receiver unit.

A transmitter of the transmitter unit and a receiver of the receiver unit may be positioned on the same side of a housing of the portable electronic apparatus.

The operational interface may comprise a display including a backlight acting as the transmitter.

The operational interface may comprise a keypad including a backlight acting as the transmitter.

The portable electronic apparatus may be a portable or handheld mobile radio communication equipment, a mobile radio terminal, a mobile telephone, a pager, a communicator, an electronic organizer, or a smartphone.

According to a second aspect, a method for controlling an operational interface of a portable electronic apparatus comprises transmitting a signal from the portable electronic device; determining whether the transmitted signal was received in the portable electronic apparatus; and controlling the operational interface if it was determined that the signal was received.

The step of transmitting may comprise generating a drive signal having a predetermined frequency for a transmitter of the portable electronic apparatus.

The method may further comprise simultaneously controlling the brightness of a light source and the frequency of an optical signal intended for a receiver of the portable electronic apparatus using the drive signal.

The step of determining may comprise inactivating at least a portion of the operational interface if it is determined that the signal was received, and not inactivate the device if it is determined that the signal was not received.

Further embodiments of the invention are defined in the dependent claims. It is an advantage of the invention that unintentional activation of an output device may be detected.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF THE DRAWINGS

Further objects, features and advantages of the invention will appear from the following detailed description of embodiments of the invention, reference being made to the accompanying drawings, in which:

FIG. 1 is a front view of a portable electronic apparatus;

FIG. 2 is a block diagram of an embodiment of the portable electronic apparatus;

FIG. 3 is cross-sectional view of an embodiment of the portable electronic apparatus;

FIG. 4 is a cross-sectional view of an embodiment of the portable electronic apparatus;

FIGS. 5a-5c are signal diagrams of embodiments of a drive signal; and

FIG. 6 is a flow-chart of one embodiment of a method for controlling an operational interface.

### DETAILED DESCRIPTION OF EMBODIMENTS

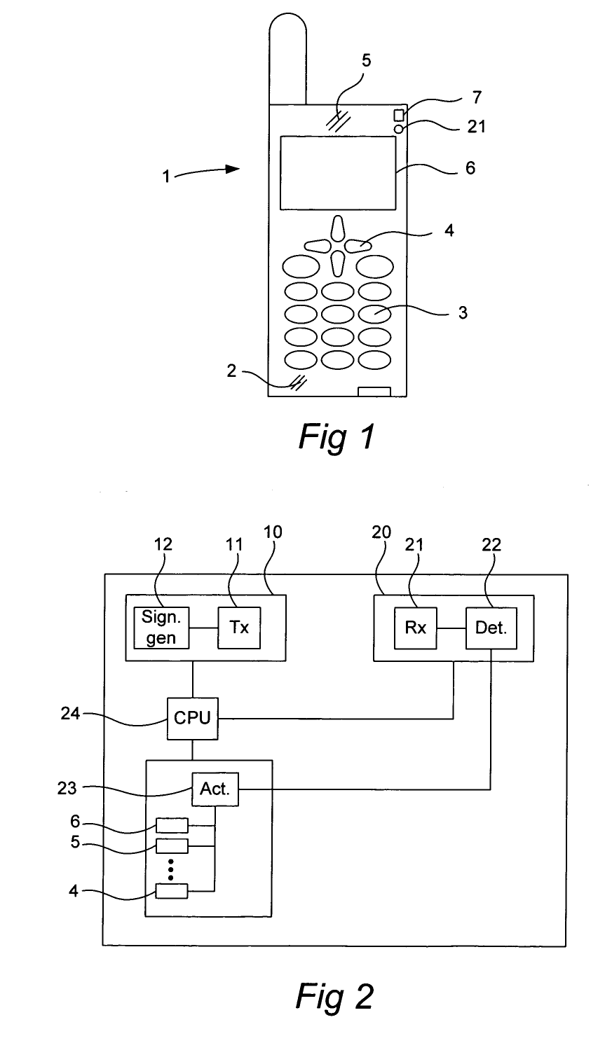

FIG. 1 illustrates a portable electronic apparatus 1. The portable electronic apparatus 1 may be a portable or handheld mobile radio communication equipment, a mobile radio terminal, a mobile telephone, a pager, a communicator, an electronic organizer, or a smartphone. In the embodiment according to FIG. 1, the portable communication apparatus 1 is embodied as a mobile terminal.

FIGS. 1 and 2 illustrate various components of the portable electronic apparatus. A user interface is provided to enable interaction with the portable electronic apparatus 1. The user interface may comprise an input interface and an output interface. Each of the input interface and the output interface may comprise an operational interface and a functional interface.

The functional input interface may comprise various input devices, such as microphones 2. The operational input interface may comprise various input devices, such as keypads 3, and joysticks or rocker pads 4. The operational input interface may also comprise various applications, such as a call establishment application. The user may input information into or activate various functions of the portable electronic apparatus 1 by means of the input devices.

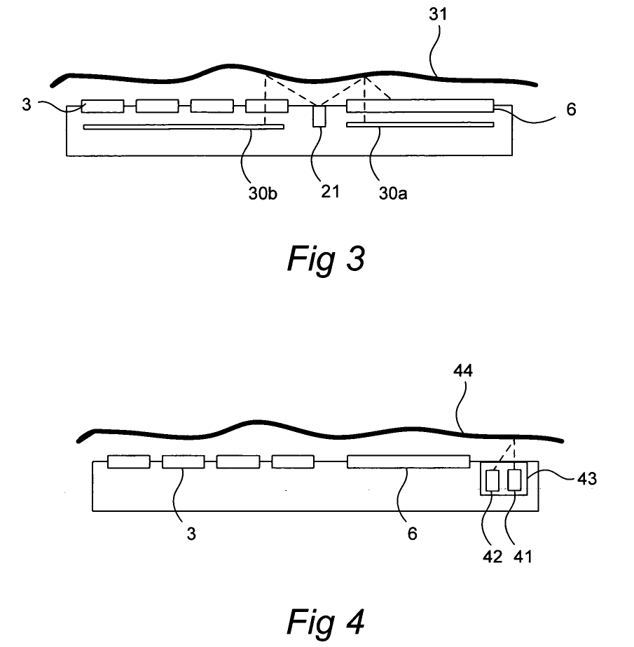

The functional output interface may comprise various output devices, such as loudspeakers 5. The operational output interface may comprise various output devices, such as displays 6, LED:s (Light Emitting Diode) 7, and backlights 30a, 30b (FIG. 3) for illuminating other devices of the operational interface, such as the display 6 and/or the keypad 3. The operational interfaces relate to the operation of the portable electronic apparatus 1.

In order to i.a. prevent unintentional activation of either of the operational input interface and/or the operational output interface, there is arranged a transmitter unit 10 including a transmitter 11. The transmitter unit 10 may also include a signal generator 12. A receiver unit 20 includes a receiver 21. The receiver unit 20 may also comprise a detector unit 22. The transmitter 11 and the receiver 21 are arranged such that when a signal is transmitted by the transmitter 11, the signal is received by the receiver 21 when the transmitter unit 10 and/or the receiver unit 20 are facing towards and are positioned in proximity of an external surface. In that position of the output device, the user cannot usually observe the output device or has no desire to observe it, wherein it may be switched off if it is in an operative state, for example to save battery power.

The transmitter 11 may be an optical transmitter, such as a light source, e.g. one or several LED:s, cold cathode ray tubes, or electroluminescence plates. Alternatively, the transmitter is an IR (Infra Red), UV (Ultra Violet) or an ultrasonic transmitter. The transmitter may also be a transmitter of a proximity detector, such as a capacitive, or IR or an acoustic proximity detector. The transmitter 21 may be provided as a separate unit or be integrated with the operational interface.

Similarly, the receiver 21 may be an optical receiver. Alternatively, the receiver is an IR, UV or ultrasonic receiver. The receiver may also be a receiver of a proximity detector, such as a capacitive, or IR or an acoustic proximity detector.

For example, the transmitter 21 may be a backlight of the operational interface, such as a backlight of the display 6 and/or the keypad 3. The keys of the keypad may be at least partly transparent. The transmitter may be positioned within a housing of the portable electronic apparatus 1. Thus, light emitted by the backlight will pass through the keys, and the backlight of the keys is provided at the same time as the backlight acts as transmitter. Similarly, the display 6 may be a transmissive or semi-transmissive display, such as an LCD (Liquid Crystal Display), having a backlight for illuminating a backside of the display panel. A transmissive display allows a viewer to observe light emitted from the backlight and transmitted through the display panel in a dark place, and to observe external light, such as natural light, reflected on the display panel without the use of backlight in a light place. Thus, the light transmitted from behind the display panel may function as backlight as well as the transmitter 11.

LED 7 may form part of the operational interface. LED 7 may be provided to indicate an operative mode of the portable electronic apparatus 1. The operative mode may be a standby mode or a communication mode. In the standby mode, LED 7 may flash with a first frequency. In the communication mode the LED 7 may flash with a second frequency. Alternatively, the LED may indicate different modes by different colours, possibly in combination with different flash frequencies.

LED 7 may also serve as the transmitter, wherein it may flash with a third frequency. The third frequency may be initiated in response to detecting activation of an input device. The duration of a drive signal having the third frequency for LED 7 may have a predetermined duration, after which a drive signal with the first or second frequency is generated or resumed.

An activation unit 23 may be provided to control the operational interface. The activation unit 23 may be adapted to activate and inactivate output devices and/or input devices of the operational interface. The activation unit 23 may be responsive to a detection indication issued by the detection unit 22. The activation unit may also activate any of the output devices in response to detecting activation of any input device, such as pressing a key of the keypad 3. Alternatively or additionally, the activation unit 23 may activate any of the output devices in response to sensing activation of an application, such as sensing an incoming call or message.

A controller 24 may be responsible for the overall operation of the transmitter unit 10 and the receiver unit 20. The controller 24 may be implemented by a CPU (Central Processing Unit). Furthermore, the controller 24 may implement the activation unit 23.

The transmitter 11 may be arranged in the housing of the portable electronic apparatus 1 such that the receiver 21 may receive a signal, such as an optical signal, transmitted by the transmitter 11. The signal may be transmitted in response to activating at least one output device of the operational interface. Thus, it is possible to detect activation of the output device, such as detecting light from a light source of the operational interface.

Furthermore, the transmitter 11 may be arranged relative the receiver 21 such that the receiver 21 receives the signal when at least one output device, such as the display 6, faces towards and is positioned in proximity of an external surface, such as the fabric of a pocket or bag, or a table surface. Positioning the output device towards the external surface may be an indication that the user does not want to use the portable electronic apparatus 1.

Unintentional activation of the output device, e.g. by unintentionally pressing a key of the keypad 3, may be detected when the output device faces and is positioned in proximity of an external surface. When the transmitter 11 is facing towards the external surface the signal is reflected against the external surface and received by the receiver 21. Thus, the receiver 21 may receive the reflected signal if it is positioned in proximity of the transmitter 11.

The receiver 21 is arranged so that it normally does not receive the signal transmitted by the transmitter. When the transmitter 11 faces the external surface, the signal is reflected so that the receiver 21 may receive the signal.

Alternatively, the receiver 21 may be arranged so that it normally receives the signal but with a signal strength below a predetermined threshold value. When the transmitter 11 faces the external surface, the signal strength at the receiver is increased above the threshold value.

The actual distance between the transmitter 11 and the receiver 21 may depend on the transmission power, free space provided around the transmitter/receiver, angles between transmitter/receiver, etc. The distance may e.g. be in the range of 2-10 mm. However, the distance may be different on other embodiments.

FIG. 3 illustrates a first embodiment of the portable electronic apparatus, wherein a backlight 30a of the display 6 acts as the transmitter. Light transmitted by the backlight 30a is reflected (indicated by dotted lines in FIG. 3) by the external surface 31. Light reflected by the external surface 31 is received by the receiver 21. The portable communication apparatus of FIG. 3 may also comprise a second backlight 30b of the keypad 3. Backlight 30b may act as the transmitter in the same manner as backlight 30a. At least one key of the keypad 3 is at least partly transparent. Thus, light transmitted by backlight 30a may pass the key and be reflected by the external surface 31 and received by the receiver 21. Backlight 30a, and 30b may together function as the transmitter. The receiver 21 may be positioned between backlight 30a and backlight 30b. Having dual transmitter sources has the advantage that the probability that the signal is reflected such that the receiver 21 may receive it increases. The backlight 30a, 30b may e.g. comprise one or several light sources, such as LEDs, cold cathode ray tubes, or one or several electroluminescence panels.

In another embodiment, the portable electronic apparatus only comprises either of backlight 30a or 30b acting as the transmitter.

FIG. 4 illustrates another embodiment wherein the transmitter 41 and the receiver 42 are positioned within a cavity 43 of the housing of the portable electronic apparatus. Transmitter 41 may e.g. be provided by one or several LED:s also acting as an indicator for indicating the operational mode of the portable electronic apparatus. Light transmitted by transmitter 41 may be reflected by external surface 44 and received by receiver 42. The cavity may be positioned on the same side of the housing of the portable electronic apparatus as at least one output device. Thus, when the output device is facing towards and is positioned in proximity of the external surface 42, the signal transmitted by the transmitter may be reflected by the external surface 42. Thus, it may be detected that the portable electronic apparatus is positioned in e.g. a pocket or a bag. Positioning the transmitter 41 and the receiver 21 in a cavity has the advantage that the signal is reflected even if the housing of the portable electronic apparatus abuts the external surface, 44.

The signal generator 12 may be adapted to generate a drive signal for the transmitter 11. The drive signal may be a modulated signal, such as a PWM (Pulse Width Modulated) signal, wherein the voltage of the drive signal is modulated. To distinguish between an optical signal, such as light, transmitted by the transmitter and normal, ambient, light (such as sun light or light from an light source external to the portable electronic apparatus), the transmitter unit 10 may be adapted to transmit an optical signal having a predefined frequency, which the receiver unit 20 is adapted to detect. The same applies for signals other than optical, such as IR or acoustic signals.

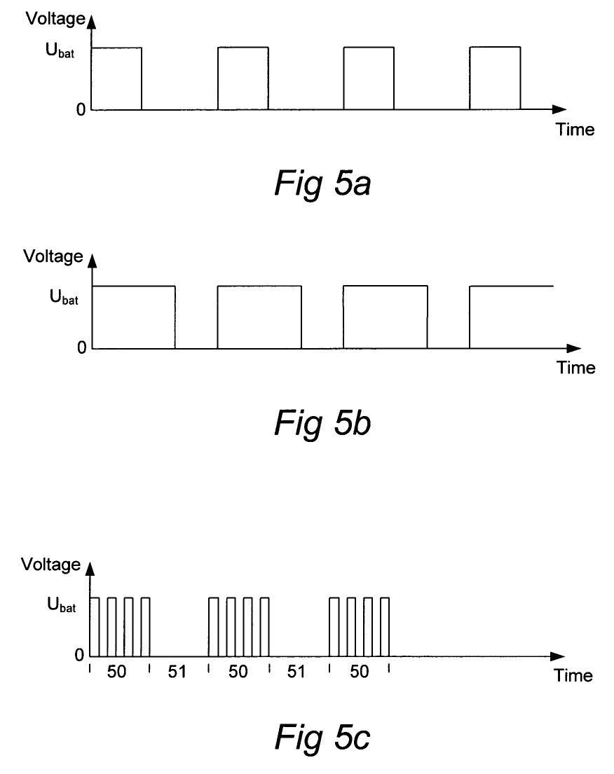

FIGS. 5a-5c illustrate embodiments of the drive signal generated by the signal generator 12 for the transmitter. The transmitter 11 may generate the optical signal in response to the drive signal. The drive signal may have a certain duty cycle. The frequency of the drive signal may in a first embodiment be in the range of 11-50 Hz. In another embodiment, the frequency of the drive signal is above 50 Hz, such as 1 kHz, wherein the on/off switching of the backlight is invisible for the human eye.

In the embodiment of FIG. 5a, the duty cycle of the drive signal is less than 50%. In the embodiment of FIG. 5b, the duty cycle is larger than 50%. In still another embodiment (not illustrated) the duty cycle may be substantially 50%. If the drive signal is applied to a light source, the brightness provided by employing the drive signal according to FIG. 5a is lower than the brightness provided by the drive signal according to FIG. 5b. The peak voltage of the drive signal during the duty cycle may correspond to the battery voltage U_{bat}.

FIG. 5c illustrates a drive signal, which can be used for simultaneously controlling the brightness of a light source and the frequency of an optical signal intended for the receiver 21. During a first time period 50, the voltage of the drive signal is oscillating, for example with a frequency of 50 kHz. The duration of the first time period is sufficient for including several oscillations, such as 0.07 ms including 3.5 oscillations as shown in FIG. 5c.

During a second time period 51, the voltage of the drive signal is constant (0 volt in this case). The duration of the second time period is selected to obtain a predetermined duty cycle for controlling the brightness of the light source, such as e.g. from 0.02 ms to 1 ms resulting in a duty cycle of 78% to 7%. Since the mean voltage during the first time period is approximately half the battery voltage, the effective duty cycle would be 39% to 3%.

The frequency of the drive signal during the first time period 50 is higher than the repetition rate of the combined first and second time period. The signal transmitted by the transmitter unit 10 during the first time period 50 may be detectable by the receiver unit 20. The duration of the combined first and second time period may be used as a brightness control for setting the brightness of a light source, such as backlight 30a and/or 30b. The brightness of the light source may be adjusted by controlling the relative length of the second time period in relation to the first time period.

The receiver 21 may be a light sensor, which is sensible to the wavelength at which the transmitter 11 transmits the signal. The receiver 21 may provide an electrical signal in response to receiving the signal. The detector may be responsive to a signal having a certain frequency. Accordingly, by modulating the drive signal, the frequency of the signal may be modulated. The electrical signal may be received by the detector 22. The detector 22 may be implemented as a pulse detector. The detector 22 may determine the frequency of the electrical signal, e.g. by counting the frequency at which pulses of the electrical signal is generated. The detector 21 may be adapted to generate a detection indication in response to detecting the predetermined frequency. The detection indication may e.g. be a signal or message. The detection indication may be transmitted to the activation unit 23. The detection indication may comprise the value of the detected frequency. The activation unit 23 may be responsive to the detection indication. The activation unit 23 may be adapted to inactivate at least one output device in response to receiving the detection indication. It is an advantage of at least some embodiments of the invention that unintentional activation of an output device may be detected. If the output device was unintentionally activated it may be inactivated very quickly, wherein the power consumption of the portable electronic apparatus is improved compared to inactivating the output device after a predetermined time period, such as 5 seconds.

Activation of an output device may also activate the transmitter unit 10 and the receiver unit 20. If the output device is unintentionally activated, e.g. when it is facing towards and is positioned in proximity to an external surface, the detection unit 23 may generate the detection indication. In response to the detection indication, the activation unit 23 may inactivate any output device having been unintentionally activated. The activation unit 23 may be responsive to a predetermined frequency. Thus, the activation unit 23 may compare the value of the detected frequency with a predetermined frequency value stored in the portable electronic apparatus 1. If the values match, at least one active output device may be inactivated. If the values do not match, the output device is maintained in an active mode at least for a predetermined period of time.

Transmission and reception between the transmitter unit 10 and the receiver unit 20 may be controlled by the controller 24. The controller may indicate to the receiver unit 20 the clock cycle at which transmission is initiated by the transmitter unit 10. Also, the duration of the duty cycle of the drive signal may be indicated, wherein the transmitter unit knows when to expect the optical signal.

However, the inactivation of the output device may be undesirable in certain circumstances, for example if a handsfree set is used, wherein the portable electronic apparatus may be positioned in the pocket. In this case, the backlight may be inactivated always, since it may not be visible to the user if the portable electronic apparatus is positioned in the pocket. On the other hand some operation may be on, such as the LED indicating operational mode. For this purpose, the portable electronic apparatus may comprise a device for detecting the presence of such a handsfree set and inactivate the feature of the present embodiment, completely or partially. Moreover, the portable electronic apparatus may include a possibility to activate and inactivate the feature of the present embodiment. In addition, the portable electronic apparatus may include an interface for adjusting operation parameters of the features of the present embodiment.

Each of the signal generator 12, the detector unit 22, and the activation unit 23 may be implemented by software code portions stored in a memory to be run by a processor, such as controller 24. Alternatively, the signal generator 12, the detector unit 22, and the activation unit 23 may be implemented in hardware. The signal generator 12 may be implemented by a VCO (Voltage Controlled Oscillator). The detector unit 22, and the activation unit 23 may be implemented by a common or separate ASIC (Application Specific Integrated Circuit) or an FPGA (Field Programmable Gate Array).

The receiver 21 may also be used for controlling the brightness of the backlight 30a, 30b. Light can be detected by the receiver 21, which generates a signal proportional to brightness of ambient light. From that information, a brightness controller, e.g. implemented by controller 24, may adjust the duty cycle of the drive signal for the backlight.

Providing detection of unintentional activation of an input device together with brightness control has the advantage that it is possible to detect whether the portable electronic apparatus 1 just is in a very dark environment or is positioned against or in proximity of an external surface. Brightness control is not needed when the portable electronic apparatus is facing an external surface at a short distance. Not having detection of unintentional activation of the output device poses a risk that the receiver indicates increased brightness to the brightness control in response to reflected light from the external surface. In response to the sensed reflected light the brightness control may increase the brightness of the backlight. Thus, the receiver may once again experience increased brightness, wherein the brightness control increases the backlight again. This could result in brightness control resonance. However, if the light transmitted by the backlight comprises a signal as described, brightness control resonance is avoided.

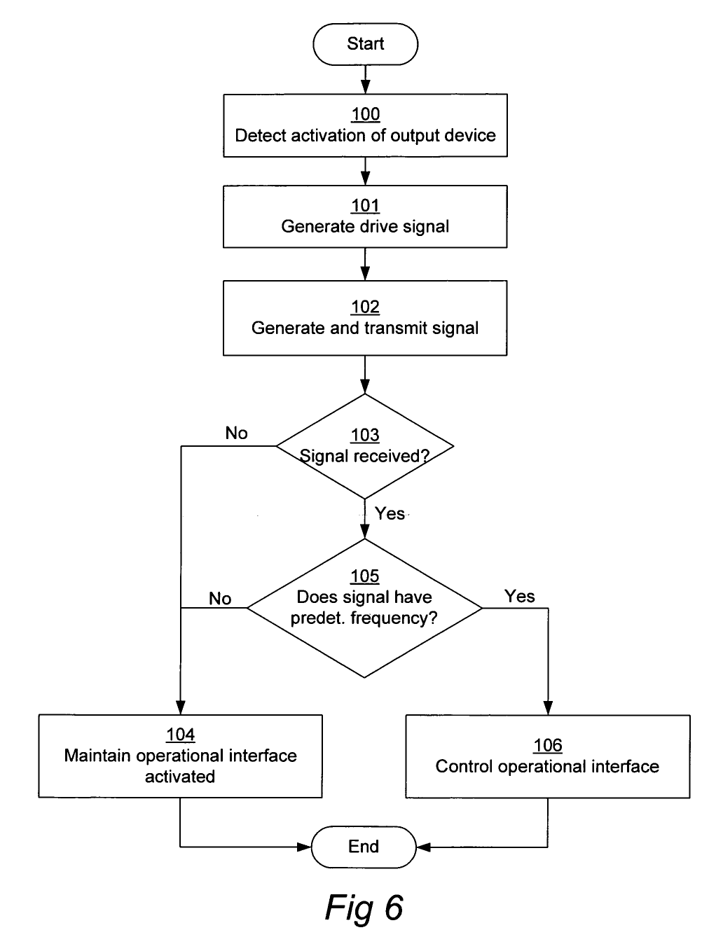

FIG. 6 illustrates an embodiment of a method for controlling an operational interface comprising an input device, and an output device. The method may be initiated in response to activating the input device, such as by pressing a key of the keypad 3. In a first step 100, activation of an output device, such as the display 6, is detected. A drive signal, such as a modulated drive signal, is generated in step 101 in response to detecting activation of the output device in step 100. In step 102, the signal is generated and transmitted by the transmitter unit 10. In step 103, it is determined whether the signal is received by the receiver unit 20. The determination in step 103 may be made by the controller 24 in response to a detection indication issued by the detector 22. If the answer in step 103 is no, the procedure proceeds to step 104. In step 104, it is determined that the output device should be maintained activated, i.e. the output device should not be inactivated and no further step need to be taken, whereby the procedure is ended. If the answer in step 103 is yes, the procedure proceeds to step 105, wherein it is determined whether the received signal has a predetermined frequency. The frequency may be detected by the detector 22 and be forwarded to the controller 24. The determination in step 105 may be performed by controller 24 by comparing it to a stored frequency value associated with the frequency of the transmitted signal. If the stored frequency value and the value of the determined frequency match it is known that the signal was transmitted by the transmitter unit 10. If the answer in step 105 is no, the procedure proceeds to step 104. If the answer in step 105 is yes, the procedure proceeds to step 106. In step 106, the operational interface is controlled. At least a portion of the operational interface, such as one output device, which is in an operative mode and thus active, may be inactivated or maintained in the operative mode. Then, the procedure is ended.

In another embodiment of the method according to FIG. 6, step 100 is not carried out and the signal transmitted in step 102 is continuously generated and transmitted. Step 103 may be carried out at predetermined time intervals to check whether the signal is received.

In above-described embodiments, the drive signal has been described as frequency of pulse width modulated. In other embodiments, the electrical signal may be phase modulated, such as phase shift modulated, which the detector 22 may be adapted to detect.

The invention may be embedded in a computer program product, which enables implementation of the method and functions described herein. The invention may be carried out when the computer program product is loaded and run in a system having computer capabilities. Computer program, software program, program product, or software, in the present context mean any expression, in any programming language, code or notation, of a set of instructions intended to cause a system having a processing capability to perform a particular function directly or after conversion to another language, code or notation.

The present invention has been described above with reference to specific embodiments. However, other embodiments than the above described are equally possible within the scope of the invention. Different method steps than those described above, performing the method by hardware or software or a combination of hardware and software, may be provided within the scope of the invention. The different features and steps of the embodiments may be combined in other combinations than those described. The scope of the invention is only limited by the appended patent claims.

1. A portable electronic device, comprising
a transmitter unit;
a receiver unit;
an operational interface; and
an activation unit adapted to control the operational interface; wherein
the transmitter unit and the receiver unit are arranged such that a signal transmitted by the transmitter unit is received by the receiver unit when the transmitter unit is facing towards and is positioned in proximity of an external surface;
the receiver unit is arranged to issue a detection indication in response to receiving the signal; and
the activation unit is responsive to the detection indication,
the transmitter unit comprises a signal generator arranged to generate a drive signal, such as a modulated drive signal, for generating the signal to be transmitted by the transmitter unit, wherein said drive signal is used for simultaneously and independently controlling the brightness of a light source and the frequency of an optical signal intended for the receiver unit, wherein a voltage of the drive signal is arranged to oscillate during a first time period and to be zero during a second time period.

2. The portable electronic device according to claim 1, wherein the activation unit is adapted to at least inactivate a portion of the operational interface in response to the detection indication.

3. The portable electronic device according to claim 1, wherein the drive signal has a predetermined duty cycle.

4. The portable electronic device according to claim 1, wherein the combined first and second time periods have a repetition rate and the frequency of the drive signal during the first time period is higher than the repetition rate.

5. The portable electronic device according to claim 1, wherein the brightness of the light source is adjusted by controlling the relative length of the second time period in relation to the first time period.

6. The portable electronic device according to claim 1, wherein a transmitter of the transmitter unit is integrated with the operational interface.

7. The portable electronic device according to claim 6, wherein the transmitter is an optical transmitter.

8. The portable electronic device according to claim 6, wherein the optical transmitter is a backlight of the operational interface.

9. The portable electronic device according to claim 1, wherein the transmitter is a LED positioned in proximity to a receiver of the receiver unit.

10. The portable electronic device according to claim 1, wherein a transmitter of the transmitter unit and a receiver of the receiver unit are positioned on the same side of a housing of the portable electronic apparatus.

11. The portable electronic device according to claim 1, wherein the operational interface comprises a display including a backlight acting as the transmitter.

12. The portable electronic device according to claim 1, wherein the operational interface comprises a keypad including a backlight acting as the transmitter.

13. The portable electronic device according to claim 1, wherein the portable electronic apparatus is a portable or handheld mobile radio communication equipment, a mobile radio terminal, a mobile telephone, a pager, a communicator, an electronic organizer, or a smartphone.

14. A method for controlling an operational interface of a portable electronic device, comprising
generating and transmitting a drive signal, such as a modulated drive signal, for simultaneously and independently controlling the brightness of a light source and the frequency of an optical signal intended for a receiver unit, wherein the generation of the drive signal comprises oscillating said drive signal during a first time period and setting the drive signal to zero during a second time period,
determining whether the transmitted signal was received in the portable electronic device, and
controlling the operational interface if it was determined that the signal was received.

15. The method according to claim 14, wherein the step of determining further comprises inactivating at least a portion of the operational interface if it is determined that the signal was received, and not inactivate the device if it is determined that the signal was not received.
